(19) United States
(12) Patent Application Publication
(10) Pub. No.: US 2015/0188461 A1
(43) Pub. Date: Jul. 2, 2015

(54) MOTOR DRIVING CONTROL APPARATUS AND METHOD, AND MOTOR DRIVING SYSTEM USING THE SAME

(71) Applicant: SAMSUNG ELECTRO-MECHANICS CO., LTD., Suwon-Si (KR)

(72) Inventors: Sang Hyun Park, Suwon-Si (KR); Joo Yul Ko, Suwon-Si (KR)

(73) Assignee: SAMSUNG ELECTRO-MECHANICS CO., LTD., Suwon-Si (KR)

(21) Appl. No.: 14/222,325

(22) Filed: Mar. 21, 2014

(30) Foreign Application Priority Data
Dec. 30, 2013 (KR) 10-2013-0167352

(51) Int. Cl. H02P 6/06; H02P 21/00; H02P 6/20

(52) U.S. Cl. CPC H02P 6/06; H02P 6/20; H02P 21/0032

(57) ABSTRACT

A motor driving control apparatus may include: a speed estimating unit calculating an estimated speed of a rotor of a motor apparatus by using phase currents flowing in a plurality of phases of the motor apparatus; a speed controlling unit generating an instruction speed by using the estimated speed and a target speed input from the outside; and a control determining unit controlling the motor apparatus to perform one of a sensorless control operation using the instruction speed and a preset synchronous start control operation, depending on whether or not the estimated speed is equal to or less than a preset value.

### CROSS-REFERENCE TO RELATED APPLICATIONS

This application claims the priority of Korean Patent Application No. 10-2013-0167352 filed on Dec. 30, 2013, in the Korean Intellectual Property Office, the disclosure of which is incorporated herein by reference.

### BACKGROUND

The present disclosure relates to a motor driving control apparatus and a motor driving control method, and a motor driving system using the same.

In accordance with increasing miniaturization and precision in motor technology, various types of motor have been developed. For example, since a permanent magnetic synchronous motor (PMSM) has excellent performance in view of efficiency, noise, and the like, as compared to other motors, it has been widely used in fields requiring high performance motors.

As a control method of the above-mentioned motor, a sensorless motor control method has recently been used according to requirements for miniaturized motors having low manufacturing costs. The sensorless motor control method estimates a position of a rotor in a motor by using back electromotive force (BEMF) generated by an operation of the motor to thereby control the motor.

However, in order to stably detect back electromotive force as mentioned above, it is necessary for the motor to rotate at a predetermined speed or faster. That is, while back electromotive force may be easily detected in a state in which the motor is being driven, it may be difficult to detect back electromotive force in a case of a starting operation from a state in which the motor is stopped, and thus, the position of such a rotor may not be able to be estimated.

A related art invention for solving the above-mentioned problem includes a scheme of performing a synchronous start control method for forcibly aligning the rotor without using back electromotive force, in a case of a motor being initially started from a stopped state, or the like.

In the case of the related art described above, a switching operation from the synchronous start control to a general driving control, for example, a control operation using back electromotive force may be imperfectly conducted, whereby the motor may be rotated unnaturally.

Particularly, since a permanent magnet synchronous motor uses a vector control method in a driving control method, while the synchronous start control method described above does not use the vector control, the motor may be rotated unnaturally, due to the switching operation between the control methods described above.

### SUMMARY

An exemplary embodiment in the present disclosure may provide a motor driving control apparatus and a motor driving control method, capable of freely performing switching between motor starting and motor driving and securing rotational stability of a motor even in the case of the switching, by estimating a speed of the motor and determining that the motor is in a starting state in a case in which the estimated speed is equal to or less than a predetermined level to thereby perform a synchronous start control operation using a vector control method, and a motor driving system using the same.

According to an exemplary embodiment in the present disclosure, a motor driving control apparatus may include: a speed estimating unit calculating an estimated speed of a rotor of a motor apparatus by using phase currents flowing in a plurality of phases of the motor apparatus; a speed controlling unit generating an instruction speed by using the estimated speed and a target speed input from the outside; and a control determining unit controlling the motor apparatus to perform one of a sensorless control operation using the instruction speed and a preset synchronous start control operation, depending on whether or not the estimated speed is equal to or less than a preset value.

The speed estimating unit and the speed controlling unit may be operated using a vector control method employing a d-q coordinate system.

The motor driving control apparatus may further include: a coordinate reverse-converting unit generating a phase voltage of the motor apparatus by receiving at least one of an output of the speed controlling unit and an output of the control determining unit and converting the received output into an N-phase coordinate system.

The control determining unit may perform the synchronous start control operation by using the d-q coordinate system when the estimated speed is equal to or less than the preset value.

The control determining unit may provide magnetic flux angle information provided from the speed estimating unit to the coordinate reverse-converting unit when the estimated speed exceeds the preset value.

The coordinate reverse-converting unit may apply the instruction speed to the magnetic flux angle information and convert an applied result into the N-phase coordinate system.

According to an exemplary embodiment in the present disclosure, a motor driving system may include: a motor apparatus including a plurality of phases; and motor driving control apparatus calculating an estimated speed of a rotor of the motor apparatus by using phase currents flowing in the plurality of phases and performing a synchronous start control operation depending on whether or not the calculated estimated speed is equal to or less than a preset value, herein the motor driving control apparatus may perform the synchronous start control operation by using a d-q coordinate system for a vector control method.

The motor driving control apparatus may include: a speed estimating unit calculating the estimated speed of the rotor of the motor apparatus by using the phase currents flowing in the plurality of phases of the motor apparatus; a speed controlling unit generating an instruction speed by using the estimated speed and a target speed input from the outside; and a control determining unit controlling the motor apparatus to perform one of a sensorless control operation using the instruction speed and a preset synchronous start control operation, depending on whether or not the estimated speed is equal to or less than a preset value.

The speed estimating unit and the speed controlling unit may be operated using the vector control method employing the d-q coordinate system.

The motor driving control apparatus may further include a coordinate reverse-converting unit generating a phase voltage of the motor apparatus by receiving at least one of an output of the speed controlling unit and an output of the control determining unit and converting the received output into an N-phase coordinate system.

The control determining unit may perform the synchronous start control operation by using the d-q coordinate system when the estimated speed is equal to or less than the preset value, and provide magnetic flux angle information provided from the speed estimating unit to the coordinate reverse-converting unit when the estimated speed exceeds the preset value.

According to an exemplary embodiment in the present disclosure, a motor driving control method performed in a motor driving control apparatus for controlling a driving of a motor apparatus, may include: estimating an angle of a rotor of the motor apparatus; performing a synchronous start control operation by using a vector control method; and calculating an estimated speed of the rotor and continuously performing the synchronous start control operation when the estimated speed is equal to or less than the preset value.

The motor driving control method may further include controlling a rotation of the rotor by using an instruction speed input from the outside according to the vector control method when the estimated speed exceeds the preset value.

The performing of the synchronous start control operation may include: setting an initial angle and a starting frequency; setting a second angle; and increasing the starting frequency and re-setting the second angle when the starting frequency is equal to or less than a preset frequency.

### BRIEF DESCRIPTION OF THE DRAWINGS

The above and other aspects, features and other advantages of the present disclosure will be more clearly understood from the following detailed description taken in conjunction with the accompanying drawings, in which:

FIG. 1 is a configuration view showing an example of a general motor driving control apparatus;

FIG. 2 is a reference diagram illustrating a synchronous start method implemented in a three-phase coordinate system;

FIG. 3 is a configuration diagram illustrating a motor driving system according to an exemplary embodiment of the present disclosure;

FIG. 4 is a configuration diagram illustrating a speed controlling unit according to an exemplary embodiment of the present disclosure shown in FIG. 3;

FIG. 5 is a flowchart illustrating a motor driving control method according to an exemplary embodiment of the present disclosure;

FIG. 6 is a flow chart illustrating an example of an operation S520 of FIG. 5; and

FIG. 7 is a flow chart illustrating an example of an operation S550 of FIG. 5.

### DETAILED DESCRIPTION

Exemplary embodiments of the present disclosure will now be described in detail with reference to the accompanying drawings.

The disclosure may, however, be exemplified in many different forms and should not be construed as being limited to the specific embodiments set forth herein. Rather, these embodiments are provided so that this disclosure will be thorough and complete, and will fully convey the scope of the disclosure to those skilled in the art.

In the drawings, the shapes and dimensions of elements may be exaggerated for clarity, and the same reference numerals will be used throughout to designate the same or like elements.

Hereinafter, a motor device refers to a motor apparatus and a motor driving control apparatus refers to an apparatus for controlling a driving of the motor apparatus. The motor driving control apparatus and the motor apparatus collectively refer to a motor driving system to be described later.

In addition, although the motor apparatus described below may be a motor apparatus having a plurality of phases, the present disclosure will be described based on an example of a three-phase motor for the convenience of explanation.

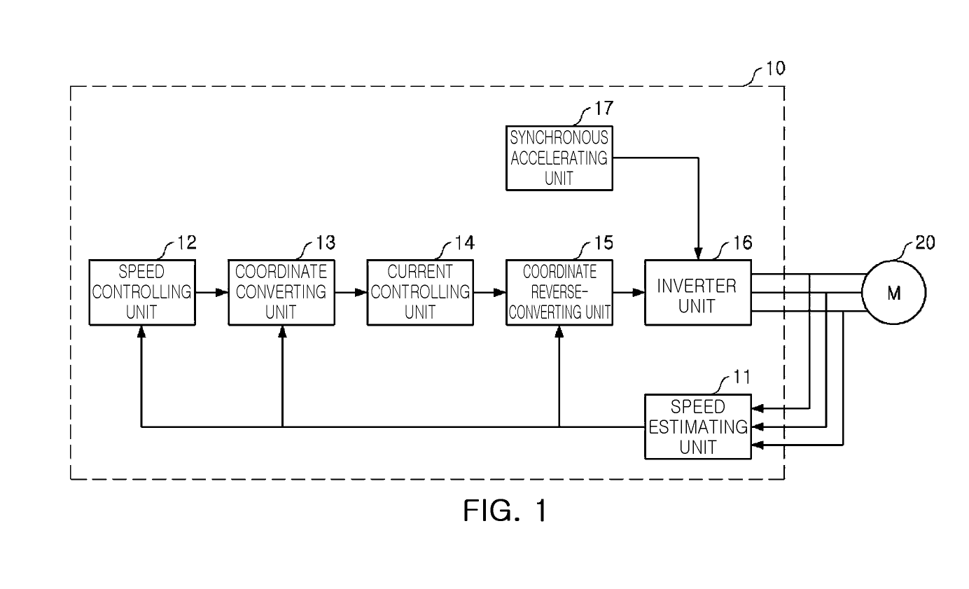

FIG. 1 is a configuration view showing an example of a general motor driving control apparatus.

Referring to FIG. 1, a motor driving control apparatus 10 may include a speed estimating unit 11, a speed controlling unit 12, a coordinate converting unit 13, a current controlling unit 14, a coordinate reverse-converting unit 15, and an inverter unit 16.

The speed estimating unit 11 may calculate an estimated speed, for example, an angular speed of a rotor of a motor apparatus 20 by using back electromotive force of the motor apparatus 20 to thereby provide the calculated speed to the coordinate reverse-converting unit 15. In addition, the speed estimating unit 11 may calculate a magnetic flux angle of the rotor to thereby provide the calculated magnetic flux angle to the speed controlling unit 12.

The speed controlling unit 12 may calculate a difference between a target speed input from the outside and the estimated speed input from the speed estimating unit 11 and calculate an instruction speed corresponding to the difference therebetween. The coordinate converting unit 13 may perform a coordinate conversion of the instruction speed into a d-q coordinate system to be provided to the current controlling unit 14. The current controlling unit 14 may generate an instruction current corresponding to the instruction speed.

The coordinate converting unit 13 may convert a three-phase coordinate system into the d-q coordinate system and the coordinate revere-converting unit 15 may convert the d-q coordinate system into the three-phase coordinate system.

Meanwhile, an initial driving of the motor apparatus from a state in which the motor apparatus is stopped, that is, a motor starting, may be performed by a synchronous accelerating unit 17. The synchronous accelerating unit 17 may forcedly rotate a rotor by applying a voltage to a stator in accordance with a preset sequence, that is, by performing a synchronous start without using back electromotive force.

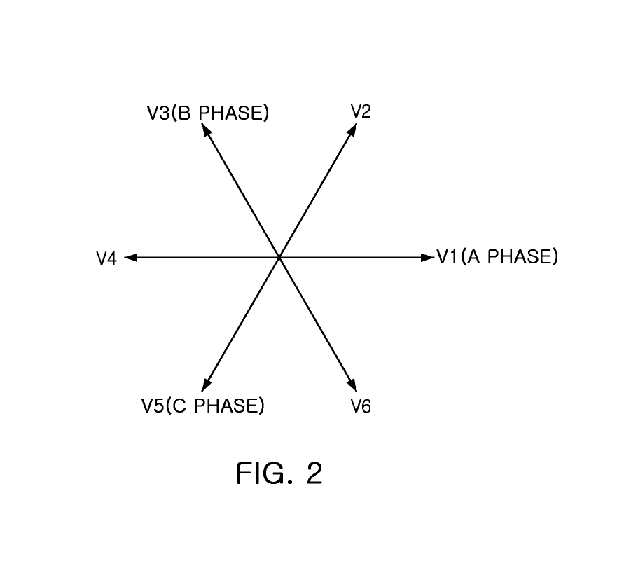

FIG. 2 is a reference diagram illustrating a synchronous start method implemented in a three-phase coordinate system and a synchronous start method of the synchronous accelerating unit 17 will be further described with reference to FIG. 2.

Since the synchronous accelerating unit 17 is operated based on the three-phase coordinate system for performing the synchronous start, a plurality of unit voltage vectors as shown in FIG. 2 may be sequentially applied to a plurality of phases of the motor apparatus 20.

That is, the synchronous accelerating unit 17 may use a scheme in which a voltage is applied to each phase of the motor apparatus to allow the rotor to be moved and disposed to the phase to which the voltage is applied. For example, when it is desired to rotate the motor in a counterclockwise direction, the motor may be rotated by applying the voltage in order of V1->V2->V3->V4->V5->V6->V1 and when it is desired to rotate the motor in a clockwise direction, the motor may be rotated by applying the voltage in a direction opposite to the direction in which the voltage is applied.

As such, if the start is performed through the synchronous start method by the synchronous accelerating unit 17, then the motor apparatus 20 is rotated, whereby back electromotive may be generated. If back electromotive force is generated, then the motor apparatus 20 may be driven through a sensorless operation by the speed estimating unit 11, the controlling unit 12, and the coordinate converting unit 13 as described above.

The motor driving control apparatus 10 shown in FIG. 1 allows the signal applied to the motor apparatus 20 to be non-continuously provided at a time in which the driving and the starting are switched, whereby the motor apparatus 20 may be unstably rotated.

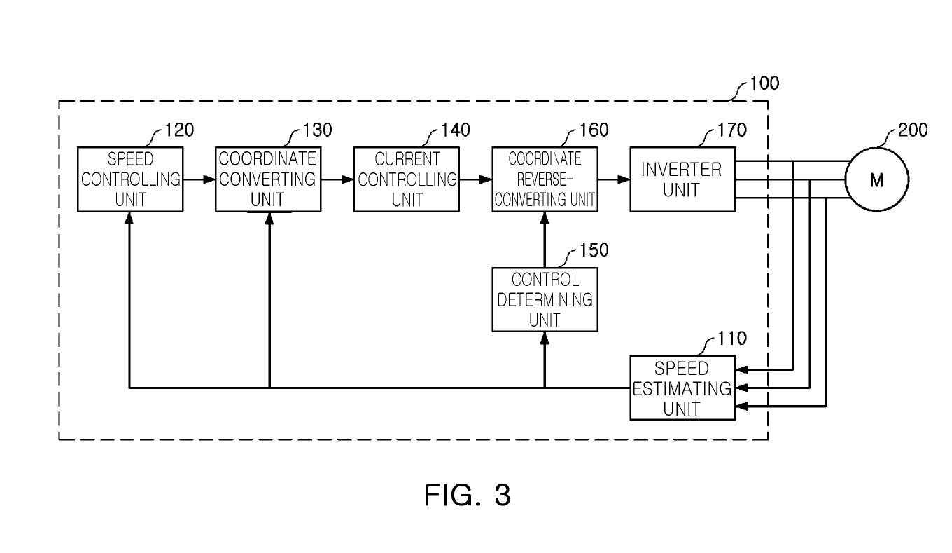

Hereinafter, various exemplary embodiments of the present disclosure capable of solving the limitations described above will be described with reference to FIGS. 3 through 7.

FIG. 3 is a configuration diagram illustrating a motor driving system according to an exemplary embodiment of the present disclosure.

Referring to FIG. 3, the motor driving system may include a motor driving control apparatus 100 and a motor apparatus 200.

The motor apparatus 200 may include a plurality of phases and FIG. 3 shows an example of a three-phase motor.

The motor driving control apparatus 100 may calculate an estimated speed of a rotor of the motor apparatus by using phase currents flowing in the plurality of phases and may perform a synchronous start control operation depending on whether or not the calculated estimated speed is equal to or less than a preset value. Here, the motor driving control apparatus 100 may perform the synchronous start control operation by using the d-q coordinate system.

More specifically, the motor driving control apparatus 100 may include a speed estimating unit 110, a speed controlling unit 120, a coordinate converting unit 130, a current controlling unit 140, a control determining unit 150, a coordinate reverse-converting unit 160, and an inverter unit 170.

The speed estimating unit 110 may calculate the estimated speed of the rotor of the motor apparatus 200 by using back electromotive force of the motor apparatus 200.

For example, the speed estimating unit 110 may calculate the phase current from back electromotive force detected by the motor apparatus 200 and may obtain an angular speed (corresponding to the estimated speed) and a magnetic flux angle of the rotor by using the calculated phase current and the voltage provided to the motor apparatus 200.

The speed estimating unit 110 may provide the calculated estimated speed of the rotor to the current controlling unit 140. In addition, the speed estimating unit 110 may provide the calculated magnetic flux angle to the control determining unit 150.

The speed controlling unit 120 may calculate a difference between a target speed input from the outside and the estimated speed input from the speed estimating unit 110 and calculate an instruction speed corresponding to the difference.

The coordinate converting unit 130 may receive an estimated angle from the speed estimating unit 110 and may perform a coordinate conversion into a d-q coordinate system, using the estimated angle. The current controlling unit 140 may perform a current control operation by using the d-q coordinate system.

For example, the speed controlling unit 120 may compare a target speed input from the outside and the estimated speed calculated by the speed estimating unit 110 with each other to thereby determine an increase or decrease in a speed of the motor apparatus 200. The current controlling unit 140 may generate and output an instruction current, depending on the difference between the target speed and the estimated speed.

The output of the current controlling unit 140 may be input to the coordinate reverse-converting unit 160 and then converted into an N-phase coordinate system, for example, the three-phase coordinate system to thereby be provided to the inverter unit 170. The reason is that calculation of a logical drive control of the motor needs to provide a phase voltage to each phase of the motor apparatus 200 by using the N-phase coordinate system in order to physically control the motor apparatus 200 even if a vector control method employing the d-q coordinate system is used.

As described above, a sensorless drive control operation of calculating the estimated speed using back electromotive force and controlling the driving of the motor apparatus 200 using the estimated speed may be performed on the basis of the detection of back electromotive force. Therefore, in the case in which the speed of the motor apparatus 200 is not sufficient to detect back electromotive force, it is difficult to use the sensorless drive control operation.

Therefore, in the case in which the motor apparatus 200 is in a stopped state or is rotated at a very slow speed, the motor driving control apparatus 100 may perform a synchronous start control operation. Therefore, a switching operation into a sensorless drive control operation or the synchronous start control operation may be required, and according to the present disclosure, the switching operation into the sensorless drive control operation or the synchronous start control operation may be performed by the control determining unit 150.

The control determining unit 150 may control the motor apparatus to perform one of the sensorless drive control operation using the instruction speed, and a preset synchronous start control operation, depending on whether or not the estimated speed provided from the speed estimating unit 110 is equal to or less than a preset value.

Here, the control determining unit 150 may perform the synchronous start control operation by using the d-q coordinate system. Therefore, since the synchronous start control operation as well as the sensorless drive control operation may use the d-q coordinate system, an irregular driving of the motor apparatus 200 caused by the switching of the coordinate system may be prevented even in the case in which the switching operation is performed from the synchronous start control operation to the sensorless drive control operation.

According to an exemplary embodiment of the present disclosure, in the case in which the estimated speed is equal to or less than a preset value, the control determining unit 150 may control the motor apparatus to perform the synchronous start control operation by using the d-q coordinate system. That is, in the case in which the estimated speed is equal to or less than a preset value, the control determining unit 150 may perform the preset synchronous start control operation by using the vector control method. The synchronous start control operation may be performed by a loop circuit configured by the speed estimating unit 110, the control determining unit 150, the coordinate converting unit 130 and the motor apparatus 200. In this case, the speed controlling unit 120 is not involved in the synchronous start control operation.

According to another exemplary embodiment of the present disclosure, in the case in which the estimated speed is equal to or less than a preset value, the control determining unit 150 may provide magnetic flux angle information provided from the speed estimating unit 110 to the coordinate reverse-converting unit 160. The sensorless drive control operation may be performed using magnetic flux angle information and the instruction speed of the speed controlling unit 120. Therefore, the coordinate reverse-converting unit 160 may apply the instruction speed to magnetic flux angle information and convert the applied result into the N-phase coordinate system to thereby provide the N-phase coordinate system to the motor apparatus 200 as a phase voltage.

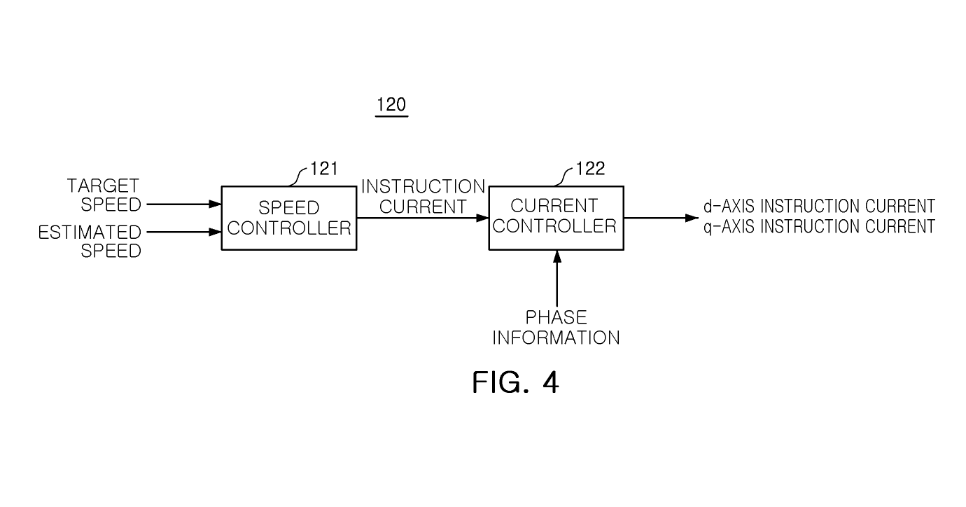

FIG. 4 is a configuration diagram illustrating a speed controlling unit according to an exemplary embodiment of the present disclosure shown in FIG. 3. Hereinafter, various components of the speed controlling unit will be described with reference to FIG. 4.

Referring to FIG. 4, the speed controlling unit 120 may include a speed controller 121 and a current controller 122.

The speed controller 121 may receive the estimated speed from the speed estimating unit 110 and may receive the target speed from the outside. The speed controller 121 may calculate the instruction speed by using a difference between the estimated speed and the target speed and may provide the calculated instruction speed to the current controller 122. Although the exemplary embodiment shows a case in which the instruction speed is provided as a current form, that is, an instruction current, the case may be changed according to exemplary embodiments of the present disclosure.

The current controller 122 may receive phase information (e.g., the magnetic flux angle) from the control determining unit 150 and the instruction speed from the speed controller 121. The current controller 122 may calculate a d-axis instruction current and a q-axis instruction current by using the instruction speed and phase information and may provide the calculated instruction currents to the coordinate reverse-converting unit 160. The coordinate reverse-converting unit 160 may convert the instruction current in the d-q coordinate system into a signal in the three-phase coordinate system to thereby provide the signal to the inverter unit 170.

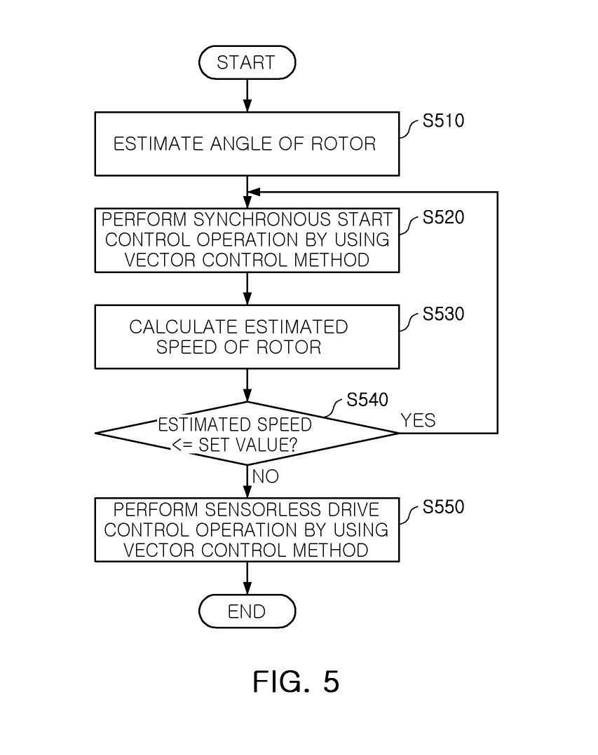

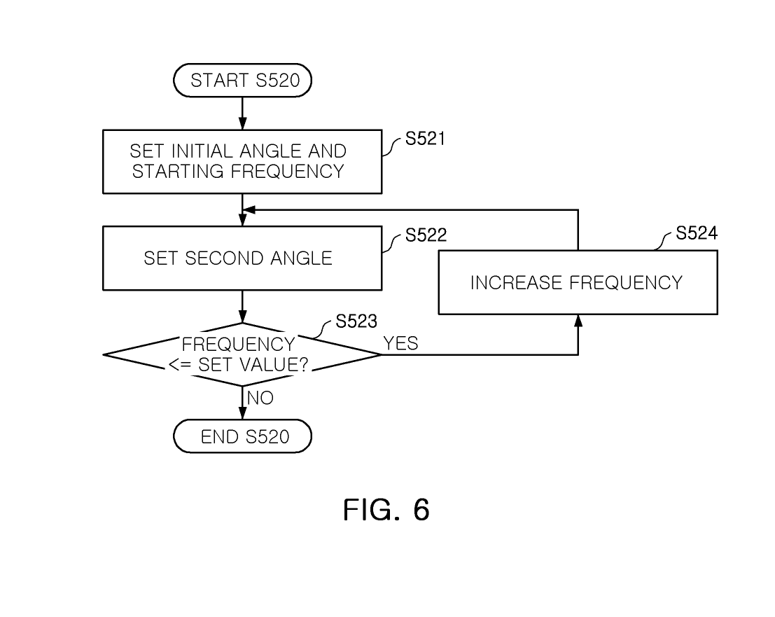

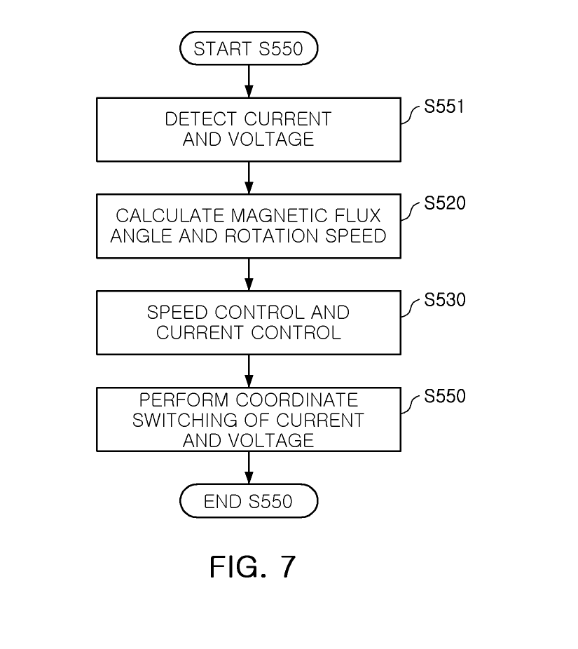

FIG. 5 is a flow chart illustrating a motor driving control method according to an exemplary embodiment of the present disclosure. FIG. 6 is a flow chart illustrating an example of an operation S520 of FIG. 5. FIG. 7 is a flow chart illustrating an example of an operation S550 of FIG. 5.

Since various examples of the motor driving control method to be described below are performed in the motor driving control apparatus described above with reference to FIGS. 3 and 4, an overlapped description for contents that are the same as or correspond to the above-mentioned contents will be omitted.

Referring to FIG. 5, the motor driving control apparatus 100 may estimate an angle of a rotor of the motor apparatus 200 (S510). In the case in which the angle of the rotor may not be estimated, then the step S510 may be omitted.

The motor driving control apparatus 100 may perform the synchronous start control operation by using the vector control method (S520).

Next, the motor driving control apparatus 100 may calculate the estimated speed of the rotor (S530).

If the estimated speed is equal to or less than a preset value (YES of S540), the motor driving control apparatus 100 may continuously perform the synchronous start control operation (S520 to S540).

Alternatively, if the estimated speed exceeds the preset value (NO of S540), the motor driving control apparatus 100 may perform the sensorless drive control operation of controlling the rotation of the rotor, by using the instruction speed input from the outside according to the vector control method.

Describing in more detail the synchronous start control operation with reference to FIG. 6, the motor driving control apparatus 100 may set an initial angle and a starting frequency (S521).

The motor driving control apparatus 100 may set a second angle (S522) and determine whether or not the starting frequency is equal to or less than a preset frequency (S523).

If the frequency is equal to or less than a preset frequency, the motor driving control apparatus 100 may increase the starting frequency and re-set the second angle (S524).

Describing in more detail the sensorless drive control operation with reference to FIG. 7, the motor driving control apparatus 100 may detect a voltage and a current of the motor apparatus (S551).

Next, the motor driving control apparatus 100 may calculate a magnetic flux angle and a rotation speed of the motor apparatus 200 by using the detected voltage and current (S552).

The motor driving control apparatus 100 may calculate an instruction speed by using the target speed input from the outside and the magnetic flux angle and may perform calculation for a speed control and a current control based on the calculated instruction speed (S553).

The motor driving control apparatus 100 may perform a coordinate switching of the calculated current and voltage (S554). Here, since operations 5552 and 5553 are performed by using the d-q coordinate system, operation S554 performs a switching of the d-q coordinate system into the N-phase coordinate system.

As set forth above, according to exemplary embodiment of the present disclosure, motor starting and motor driving may be freely switched and rotational stability of the motor may be secured even in a case of the switching by estimating the speed of the motor and determining that the motor is in a starting state in the case in which the estimated speed is equal to or less than a predetermined level to thereby perform the synchronous start control operation using the vector control method.

While exemplary embodiments have been shown and described above, it will be apparent to those skilled in the art that modifications and variations could be made without departing from the spirit and scope of the present disclosure as defined by the appended claims.

What is claimed is:

1. A motor driving control apparatus comprising:
a speed estimating unit calculating an estimated speed of a rotor of a motor apparatus by using phase currents flowing in a plurality of phases of the motor apparatus;
a speed controlling unit generating an instruction speed by using the estimated speed and a target speed input from the outside; and
a control determining unit controlling the motor apparatus to perform one of a sensorless control operation using the instruction speed and a preset synchronous start control operation, depending on whether or not the estimated speed is equal to or less than a preset value.

2. The motor driving control apparatus of claim 1, wherein the speed estimating unit and the speed controlling unit are operated using a vector control method employing a d-q coordinate system.

3. The motor driving control apparatus of claim 2, further comprising: a coordinate reverse-converting unit generating a phase voltage of the motor apparatus by receiving at least one of an output of the speed controlling unit and an output of the control determining unit and converting the received output into an N-phase coordinate system.

4. The motor driving control apparatus of claim 3, wherein the control determining unit performs the synchronous start control operation by using the d-q coordinate system when the estimated speed is equal to or less than the preset value.

5. The motor driving control apparatus of claim 3, wherein the control determining unit provides magnetic flux angle information provided from the speed estimating unit to the coordinate reverse-converting unit when the estimated speed exceeds the preset value.

6. The motor driving control apparatus of claim 5, wherein the coordinate reverse-converting unit applies the instruction speed to the magnetic flux angle information and converts an applied result into the N-phase coordinate system.

7. A motor driving system, comprising:
a motor apparatus including a plurality of phases; and
a motor driving control apparatus calculating an estimated speed of a rotor of the motor apparatus by using phase currents flowing in the plurality of phases and performing a synchronous start control operation depending on whether or not the calculated estimated speed is equal to or less than a preset value,
wherein the motor driving control apparatus performs the synchronous start control operation by using a d-q coordinate system for a vector control method.

8. The motor driving system of claim 7, wherein the motor driving control apparatus includes:
a speed estimating unit calculating the estimated speed of the rotor of the motor apparatus by using the phase currents flowing in the plurality of phases of the motor apparatus;
a speed controlling unit generating an instruction speed by using the estimated speed and a target speed input from the outside; and
a control determining unit controlling the motor apparatus to perform one of a sensorless control operation using the instruction speed and a preset synchronous start control operation, depending on whether or not the estimated speed is equal to or less than a preset value.

9. The motor driving system of claim 8, wherein the speed estimating unit and the speed controlling unit are operated by using the vector control method employing the d-q coordinate system.

10. The motor driving system of claim 9, wherein the motor driving control apparatus further includes a coordinate reverse-converting unit generating a phase voltage of the motor apparatus by receiving at least one of an output of the speed controlling unit and an output of the control determining unit and converting the received output into an N-phase coordinate system.

11. The motor driving system of claim 10, wherein the control determining unit performs the synchronous start control operation by using the d-q coordinate system when the estimated speed is equal to or less than the preset value, and provides magnetic flux angle information provided from the speed estimating unit to the coordinate reverse-converting unit when the estimated speed exceeds the preset value.

12. A motor driving control method performed in a motor driving control apparatus for controlling a driving of a motor apparatus, the motor driving control method comprising:
estimating an angle of a rotor of the motor apparatus;
performing a synchronous start control operation by using a vector control method; and
calculating an estimated speed of the rotor and continuously performing the synchronous start control operation when the estimated speed is equal to or less than the preset value.

13. The motor driving control method of claim 12, further comprising: controlling a rotation of the rotor by using an instruction speed input from the outside according to the vector control method when the estimated speed exceeds the preset value.

14. The motor driving control method of claim 12, wherein the performing of the synchronous start control operation includes:
setting an initial angle and a starting frequency;
setting a second angle; and
increasing the starting frequency and re-setting the second angle when the starting frequency is equal to or less than a preset frequency.
